(19) United States
(12) Patent Application Publication
(10) Pub. No.: US 2006/0095959 A1
(43) Pub. Date: May 4, 2006

(54) System and method to provide umts and internet authentication

(76) Inventors: Andrew Gordon Williams, Swindon (GB); Andrew James Parker, Sutton (GB)

Correspondence Address: MORRISON & FOERSTER LLP, 425 MARKET STREET, SAN FRANCISCO, CA, 94105-2482, US

(21) Appl. No.: 10/530,638

(22) PCT Filed: Oct. 8, 2003
(86) PCT No.: PCT/GB03/04315

§ 371 Date: Nov. 8, 2005

(30) Foreign Application Priority Data
Oct. 8, 2002 (GB) 0223311.2

(51) Int. Cl. G06F 17/30

(52) U.S. Cl. 726/8

(57) ABSTRACT

System (FIG. 2) and method for use of internet authentication technology to provide UMTS authentication. An SGSN (260) in an Integrated Network Contoroller (240) in a UMTS network and a RADIUS server (270) are adapted to support signalling therebetween whereby authentication of a USIM is performed in the RADIUS Server. This allows a conventional Authorisation Centre (AuC) to replaced by the RADIUS Server, and it is substantially cheaper, because it is based largely on existing off-the-shelf Internet access authentication technology, modified to this purpose.

### FIELD OF THE INVENTION

This invention relates to Wireless Internet Access systems, and in particular those based on UMTS 3G (Universal Mobile Telecommunication System 3^{rd} Generation) mobile standards.

### BACKGROUND OF THE INVENTION

The UMTS standards describe a particular method by which an end-user's piece of equipment (UE) is authenticated and also the mechanism by which the UE authenticates the network (to prevent it connecting to bogus base stations). These require particular signalling from the SGSN (Serving General Packet Radio Service Support Node) element to a UMTS HLR/AuC (Home Location Register/Authentication Centre). This is covered in the following standards documents:
[1] TS 33.102—3rd Generation Partnership Project; Technical Specification Group Services and System Aspects; 3G Security; Security Architecture; (Release 1999), and
[2] TS 24.008—3rd Generation Partnership Project; Technical Specification Group Core Network; Mobile radio interface layer 3 specification; Core Network Protocols—Stage 3; (Release 1999).

The standards also recommend an algorithm set for such authentication functions:
[3] TS 35.205—3rd Generation Partnership Project; Technical Specification Group Services and System Aspects; 3G Security; Specification of the MILENAGE Algorithm Set: An example algorithm set for the 3GPP authentication and key generation functions f1, f1*, f2, f3, f4, f5 and f5*; Document 1: General (Release 4), and
[4] TS 35.206—3rd Generation Partnership Project; Technical Specification Group Services and System Aspects; 3G Security; Specification of the MILENAGE Algorithm Set: An example algorithm set for the 3GPP authentication and key generation functions f1, f1*, f2, f3, f4, f5 and f5*; Document 2: Algorithm Specification (Release 4).

However, this known approach has the disadvantage(s) that due to the complexity of the existing standards and the relatively small market for such elements it is expensive to implement, and generally based on bespoke software, and in some cases bespoke hardware.

From patent publication no. WO 02/11467 there is known use of RADIUS (Remote Authentication Dial-In User Service) and associated protocols to authenticate network access for fixed end users and for end users who roam in a wireless system. RADIUS is standardized by the IETF (Internet Engineering Task Force) in the document:
[5] RFC 2865—Remote Authentication Dial In User Service.

The standards documents [1]-[5] referred to above are hereby incorporated herein by reference.

However, this known use of RADIUS supports authentication for end users using UE associated with a computer such as a PC (Personal Computer). It does not facilitate support of USIM (UMTS Subscriber Identity Module) cards in UE.

A need therefore exists for use of internet authentication technology to provide UMTS authentication services related to USIMs wherein the abovementioned disadvantage(s) may be alleviated.

### STATEMENT OF INVENTION

In accordance with the present invention there is provided a system and a method for use of internet authentication technology to provide UMTS authentication as claimed in claim 1 and claim 15 respectively.

### BRIEF DESCRIPTION OF THE DRAWINGS

One system and method use of internet authentication technology to provide UMTS authentication services related to UMTS SIM cards (USIMs) incorporating the present invention will now be described, by way of example only, with reference to the accompanying drawing(s), in which:

FIG. 1 shows a block schematic diagram illustrating signal sequencing in a prior art system to authenticate a user;

FIG. 2 shows a block schematic diagram of a UTRAN Internet system illustrating the present invention;

FIG. 3 shows a block schematic diagram illustrating signal sequencing during normal authentication process in the system of FIG. 2; and

FIG. 4 shows a block schematic diagram illustrating signal sequencing during anti-replay data synchronisation process in the system of FIG. 2.

### DESCRIPTION OF PREFERRED EMBODIMENT(S)

The UMTS standards describe a particular method by which an end-user's piece of equipment (UE) is authenticated and also the mechanism by which the UE authenticates the network (to prevent it connecting to bogus base stations). These require particular signalling from the SGSN element to a UMTS Home Location Register/Authentication Centre (HLR/AuC). This is covered in the standards documents [1], [2], [3] & [4] referred to above.

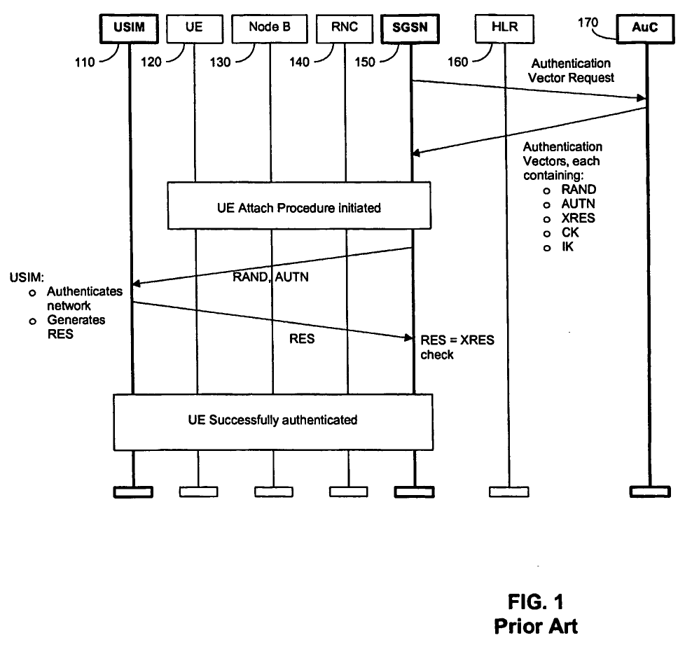

As shown in FIG. 1, the method of the UMTS standards utilises the network elements USIM 110, UE 120, Node B 130, RNC 140, SGSN 150, HLR 160 and AuC 170. The authentication-related signalling effectively occurs between the USIM 110, SGSN 150 and AuC 170.

The AuC 160 generates a set of authentication and keying material, called an Authentication Vector; sets of Authentication Vectors are sent to the SGSN 150 by the AuC 170, at the request of the SGSN.

The authentication of a UE 120 occurs when it ‘attaches’ to the network:

On an attempted network attach from a UE 120, the SGSN 150 selects an existing Authentication Vector, or requests fresh Authentication Vectors from the AuC 170. The SGSN then supplies the random challenge value (RAND) and the Authentication Token (AUTN) values from the Authentication Vector to the USIM 110.

The USIM uses a shared secret value (shared with the AuC) referred to as K, plus any other parameters demanded by the authentication algorithm (the UMTS standards supply an example algorithm called MILENAGE, which has the values OP—Operator Variant Configuration Field—and AMF—Authentication Management Field) to authenticate the network by validating the AUTN value it received. The authentication algorithm also includes a scheme to prevent replay-attacks (where a sequence of authentication messages is recorded, then re-played at a later time, in order to gain un-authorised access to a service) based on synchronised changing values in the AuC to the USIM (in the MILENAGE algorithm this is achieved using a changing sequence number shared between USIM and AuC, referred to as SQN).

If the USIM authenticates the network successfully, it generates an authentication result value (RES) and sends it back to the SGSN.

The SGSN compares RES against XRES and if they match authentication completes and the UE is allowed onto the network.

When the USIM authenticates the network, it can detect out-of-synchronisation anti-replay-attack data between it and the AuC—in this case a re-synchronisation procedure is executed between the USIM and AuC and the authentication procedure is then re-executed.

As will be described in greater detail below, in its preferred embodiment the present invention is based on an Internet technology-based authentication server, using a commercial RADIUS authentication server platform, that implements the procedures such that:
the SGSN function within an Integrated Network Controller (INC—comprising RNC and SGSN functionality) can obtain the required authentication and keying material to authenticate a UE containing a USIM; and
the network authentication function within the USIM can authenticate the INC.

As described in the present applicant's co-pending patent application Ser. No. 09/432,824 (published in equivalent form as EP 1098539) and co-pending patent application no. GB 0114813.9, the contents of which applications are hereby incorporated herein by reference, a combined RNC/SGSN may be supported in a single network element. In this configuration the function of the HLR and AuC can be replaced with a RADIUS based Internet authentication server, as described in the present applicant's co-pending patent application Ser. No. 09/626,700 (published in equivalent form as WO 02/11467), the content of which is hereby incorporated herein by reference.

The present invention is based on the realisation by the inventors that the earlier-described use of RADIUS to authenticate the UE for wireless access, can be extended by extensive modification of the signalling procedures to support the use of USIM cards in the UE. The signalling required to implement this in detail below.

The RADIUS protocol allows for vendor-specific extensions to messages. Commercial RADIUS server software also supports the addition of software functionality (‘plug-in’) to process/create RADIUS messages, including attributes added as extensions to the RADIUS protocol. The present invention is based on the realisation by the inventors that the functionality of the UMTS AuC, and the associated signalling with the SGSN, can be replaced by extensions to the RADIUS protocol and a software ‘plug-in’ on the RADIUS server.

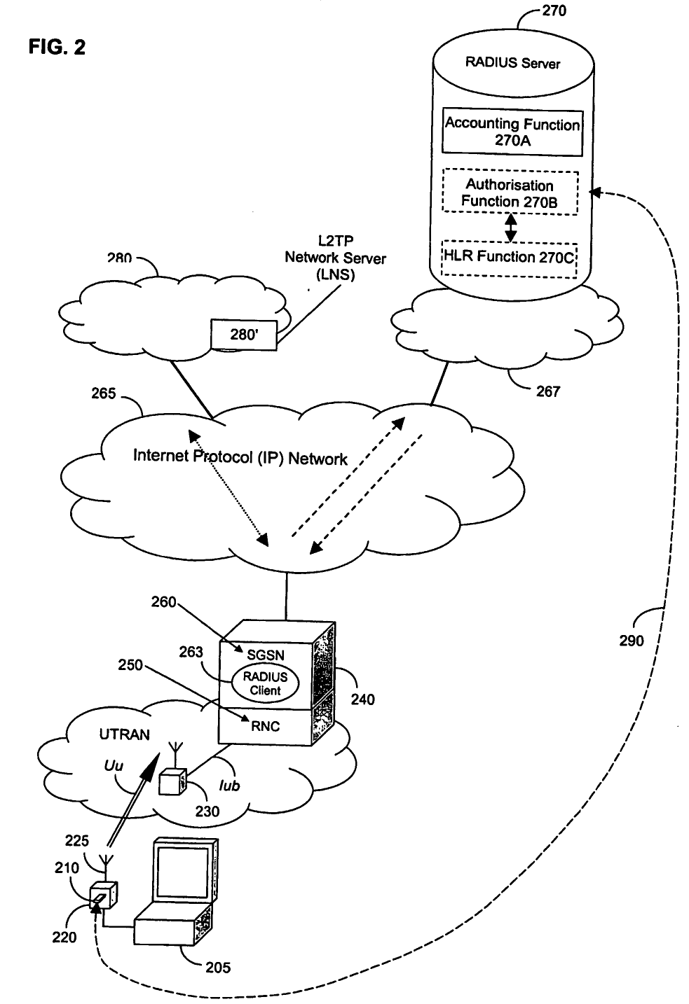

Referring now to FIG. 2, a wireless access user of the Internet access system has a PC (Personal Computer) 205 and UMTS user equipment (UE) 220 containing a USIM card 210. The UE has a directly attached antenna 225 and is connected by typical wired data connection such as RS232, USB or Ethernet to the PC 205. The UE 220 and USIM 210 are together commonly termed a mobile terminal, operating in conjunction with the associated PC 205 (which is commonly termed terminal equipment).

The UE 220 communicates over a wireless link Uu with a base station or Node B 230 in an access network domain of a UTRAN netowrk. The Node B 230 communicates over a link Iub with an integrated network controller (INC) 240. As discussed above, the INC 240 includes an RNC (Radio Network Controller) 250, which controls and allocates the radio network resources and provides reliable delivery of user traffic between the Node B 230 and the UE 220, and an SGSN (Serving General Packet Radio Service Support Node) 260, which provides session control. The SGSN 260 incorporates a RADIUS element designated RADIUS client 263 to provide authentication and other functions, as will be described in greater detail below.

The INC 240 is connected to an Internet protocol network 265 and then to a UMTS access network operator 267, having a RADIUS server 270. The RADIUS server 270 incorporates RADIUS Accounting Functions 270A, and Authentication Functions 270B and HLR Functions 270C (these functions are shown in dashed line in FIG. 2 because, as will be described in greater detail below, the functionality is provided in software in the RADIUS Server, rather than by provision of a dedicated AuC and HLR as previously known). The RADIUS server 270 is the server for both authentication and accounting functions. Thus, after authentication normally the user would communicate via the network 265 with target Internet service provider 280 through its Layer 2 Tunneling Protocol Network Server LNS 280′.

As will be explained in greater detail below, a link 290 is effectively established between the USIM 210 and authentication functionality 270B within the RADIUS server 270, allowing authetication of the USIM 210 without requiring a dedicated authentication centre and a dedicated home location register.

The RADIUS Server 270:
Is provisioned with the IMSI-derived User-Name derived from the numeric IMSI identifier within the USIM (e.g., for an IMSI value of 234151234567890 the RADIUS User-Name attribute might be “234151234567890_attach”) and also the set of security parameters required to support generation of the various parts of a UMTS Authentication Vector.
Has had its RADIUS attribute dictionary extended, to include a ‘UMTS-Authentication-Vector’ attribute, containing RAND, AUTN, CK, IK and XRES with the same functionality (size in bits) as the values defined in UMTS standards document [3] referred to above.
Has its RADIUS attribute dictionary extended, to include a ‘UMTS-Resynchronisation-Token’ attribute, containing a value with the same definition as the AUTS parameter described in UMTS standards document [3] referred to above.
Has a software plug-in that supports generation of a UMTS-Authentication-Vector RADIUS attribute, based on the provisioned security parameters and the dynamic anti-replay parameters.
Has a software plug-in that supports re-synchronisation of the dynamic anti-replay parameters with the USIM, on reception of a UMTS-Resynchronisation-Token attribute.

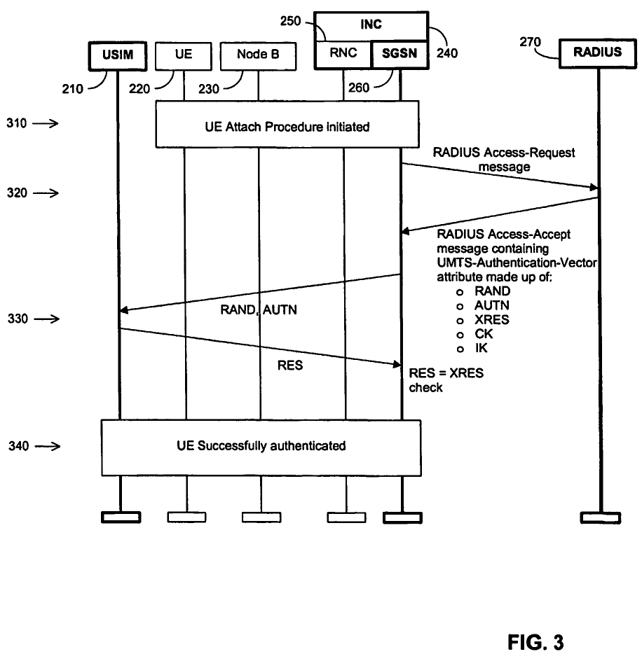

Referring now also to FIG. 3, the normal authentication process is as follows:
310—The UE 220 initiates the attach procedure.
320—The SGSN module 260 within the INC 240 requests a single Authentication vector, via a RADIUS Access-Request message; the RADIUS User-Name attribute (see the IETF standards document [5] referred to above) contains a RADIUS user ID derived from the numeric IMSI identifier within the USIM (e.g., for the IMSI value “0123456789012345” the User-Name attribute would contain the value: “0123456789012345_attach”).
   The RADIUS server plug-in derives a UMTS-Authentication-Vector attribute (made up of: RAND, AUTN, XRES, CK and IK values) based on the provisioned information and the dynamic anti-replay-attack information. The attribute is returned to the SGSN module 260 within the INC 240 in an Access-Accept RADIUS message.
330—The USIM 210 authenticates the network, using RAND and AUTN values received from the SGSN, then generates an authentication result value (RES) and sends it back to the SGSN module 260 within the INC 240.
340—The SGSN module 260 within the INC 240 compares RES against XRES and if they match authentication completes and the UE 220 is allowed onto the network.

The following table describes how the RADIUS Access-Request message and the RADIUS Access-Accept message can be constructed:

| Message | Contained Attribute | Type/Value | Notes |
|---|---|---|---|
| Access- | User-Name | Octet string | IMSI from SIM card |
| Request | | | with “_attach” |
| | | | appended to it |
| | User-Password | Octet string | Default value |
| | | | inserted by INC |
| | NAS-IP-Address | IP Address | |
| | User-Name-Type | Enumerated | Identifies whether |
| | | value | the User-Name |
| | | | value represents |
| | | | an IMSI |
| Access- | Vendor-Specific | Octet String | 72-76 Byte |
| Accept | (UMTS- | | concatenation of |
| | Authentication- | | authentication |
| | Vector) | | material as defined in |
| | | | 3GPP specifications |

The Octet String of the RADIUS Access-Accept message is constructed as shown in the following table:

Octets

| | | | |
|---|---|---|---|
| 0 | 1 | 2 | 3 |

| | | |
|---|---|---|
| Type | Length | Vendor-ID |

| | | |
|---|---|---|
| Vendor-ID (continued) | Manuf.-Type | Manuf.-Length |

RAND (128 bit)
CK (128 bit)
IK (128 bit)
AUTN (128 bit)
XRES (64-128 bit)

The ‘Type’ field has a vendor-specific value (e.g., 26).

The ‘Length’ field has a typical value of 80.

The ‘Vendor-ID’ field has the vendor's IANA-assigned value (e.g., 5586).

The ‘Manuf.-Type’ (Manufacturer-Type) field has the UMTS-Authentication-Vector value of 14.

The ‘Manuf.-Length’ field has a value in the range 74-78.

The Value field (RAND, CK, IK, AUTN and XRES) is 72-76 octets of concatenated authentication material to be used by the INC in Access Authentication, challenge and ciphering.

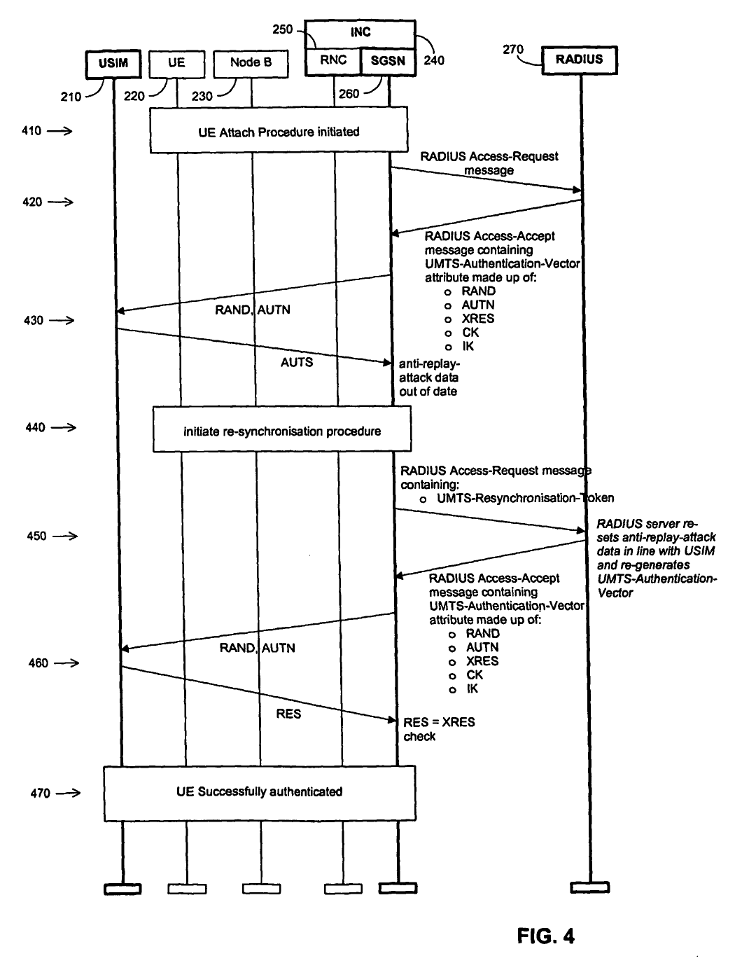

Referring now also to FIG. 4, the anti-replay data synchronisation process is as follows:
410—The UE 220 initiates the attach procedure.
420—The SGSN module 260 within the INC 240 requests a single Authentication vector, via a RADIUS Access-Request message; the RADIUS User-Name attribute (see the IETF standards document [5] referred to above) contains a RADIUS user ID derived from the numeric IMSI identifier within the USIM (e.g., for an IMSI value of 234151234567890 the RADIUS User-Name attribute might be “234151234567890_attach”).
   The RADIUS server plug-in derives a UMTS-Authentication-Vector attribute (made up of: RAND, AUTN, XRES, CK and IK values) based on the provisioned information and the dynamic anti-replay-attack information. The attribute is returned to the SGSN module 260 within the INC 240 in an Access-Accept RADIUS message.
430—The USIM 210 authenticates the network, using RAND and AUTN values received from the SGSN 260, and it detects that the anti-replay-attack data is out of synchronisation, but all other data is correct. The USIM 210 sends a message to the SGSN 260 containing the value AUTS (see the UMTS standards document [2] referred to above), signifying that the anti-replay attack data is out of date.
440—In this case the USIM initiates the re-synchronisation procedure.
450—The SGSN module 260 within the INC 240 requests a single Authentication vector, via a RADIUS Access-Request message; this message also includes the UMTS AUTS value in a UMTS-Resynchronisation-Token RADIUS attribute, which contains a hidden version of its anti-replay-attack information from the USIM.
   The RADIUS server plug-in re-synchronises the anti-replay attack information, then derives a UMTS-Authentication-Vector attribute based on the provisioned information and the now back-in-sync dynamic anti-replay information. The UMTS-Authentication-Vector attribute is returned to the SGSN module 260 within the INC 240 in an Access-Accept RADIUS message.
460—The USIM authenticates the network, using RAND and AUTN values received from the SGSN 260, then generates an authentication result value (RES) and sends it back to the SGSN module within the INC.
470—The SGSN module within the INC compares RES against XRES and if they match authentication completes and the UE is allowed onto the network.

The message sent from the USIM 210 to the SGSN 260 at step 430 above, signifying that the anti-replat-attack data is out of date, is constructed as shown in the following table:

Octets

| | | | |
|---|---|---|---|
| 0 | 1 | 2 | 3 |

| | | |
|---|---|---|
| Type | Length | Vendor-ID |

| | | |
|---|---|---|
| Vendor-ID (continued) | Manuf.-Type | Manuf.-Length |

AUTS (112 bit)

The ‘Type’ field has a vendor-specific value (e.g., 26).

The ‘Length’ field has a typical value of 22.

The ‘Vendor-ID’ field has the vendor's IANA-assigned value (e.g., 5586).

The ‘Type’ field has the UMTS-Resynchronisation-Token value of 15.

The ‘Manuf.-Length’ field has a value of 16.

The Value field (AUTS) is 14 octets of concatenated authentication material to be used by the RADIUS server 270 in USIM sequence number resynchronisation.

It will be understood that by extending the signalling procedures as described above, RADIUS may be used to authenticate a USIM card in a UE for wireless access in a UMTS system, by effectively establishing a link between the USIM and authentication functionality within the RADIUS server (as shown by the link 290 in FIG. 2) without requiring a dedicated authentication centre (and a dedicated home location register).

It will be appreciated that the method described above for use of internet authentication technology to provide UMTS authentication may be carried out in software running on one or more processors (not shown) in the RADIUS server 270, the SGSN module 260 and the PC carrying the USIM 210, and that the software may be provided as a computer program element carried on any suitable data carrier (also not shown) such as a magnetic or optical computer disc.

It will be understood that the use of internet authentication technology to provide UMTS authentication services related to UMTS SIM cards (USIMs) described above provides the following advantages:
it is substantially cheaper than prior art solutions, because
it is based largely on existing off-the-shelf Internet access authentication technology, modified (conveniently in software in the USIM, SGSN and/or RADIUS server) to this purpose.

1. A system for use of internet authentication technology to provide UMTS authentication, the system comprising:
Serving GPRS Support Node (SGSN) means in a UMTS network; and
RADIUS server means,
the SGSN means and the RADIUS Server means being adapted to support signalling therebetween whereby authentication of a User Subscriber Identity Module (USIM) may be performed in the RADIUS Server means.

2. The system of claim 1 wherein the SGSN means is integrated with Radio Network Controller (RNC) means in Integrated Network Controller (INC) means.

3. The system of claim 1 or 2 wherein the UMTS network comprises a UMTS Terrstrial Radio Access Network (UTRAN).

4. The system of any preceding claim wherein the SGSN means is adapted to send an Access-Request RADIUS message to request a UMTS Authentication Vector from the RADIUS server means.

5. The system of any preceding claim wherein the RADIUS Server means is adapted to generate authentication and keying material so as to authenticate a USIM within a UMTS UE, according to UMTS standards.

6. The system of claim 5 wherein the RADIUS Server means is adapted to implement the MILENAGE algorithm.

7. The system of claim 5 or 6 wherein the RADIUS Server means is adapted to generate, using anti-replay-attack dynamic data, a UMTS Authentication Vector, for use by the SGSN means.

8. The system of claim 5 when dependent on claim 4 wherein the RADIUS Server means is adapted to support dynamic sequence number (SQN).

9. The system of any preceding claim wherein the RADIUS Server means is adapted to generate a UMTS Authentication Vector in a RADIUS attribute within an Access-Accept RADIUS message for sending to the SGSN means.

10. The system of any preceding claim wherein the SGSN means is adapted to receive a UMTS Authentication Vector in a RADIUS Access-Accept message.

11. The system of any preceding claim wherein the SGSN means is adapted to send information to re-synchronise anti-replay-attack information within the USIM with the RADIUS Server means.

12. The system of claim 11 when dependent on claim 4 wherein SGSN means is adapted to send a UMTS-Resynchronisation-Token attribute in the Access-Request RADIUS message.

13. The system of claim 12 wherein the RADIUS Server means is adapted to reset anti-replay-attack dynamic data in-line with the USIM in response to the data received in the UMTS-Resynchronisation-Token.

14. The system of claim 13 wherein the RADIUS Server means is adapted to implement the MILENAGE algorithm.

15. A method for use of internet authentication technology to provide UMTS authentication, the method comprising:
providing Serving GPRS Support Node (SGSN) means in a UMTS network; and
providing RADIUS server means,
signalling between the SGSN means and the RADIUS Server means so that authentication of a User Subscriber Identity Module (USIM) is performed in the RADIUS Server means.

16. The method of claim 15 wherein the SGSN means is integrated with Radio Network Controller (RNC) means in Integrated Network Controller (INC) means.

17. The method of claim 15 or 16 wherein the UMTS network comprises a UMTS Terrstrial Radio Access Network (UTRAN).

18. The method of any one of claims 15-17 wherein the SGSN means sends an Access-Request RADIUS message to request a UMTS Authentication Vector from the RADIUS server means.

19. The method of any one of claims 15-18 wherein the RADIUS Server means generate authentication and keying material so as to authenticate a USIM within a UMTS UE, according to UMTS standards.

20. The method of claim 19 wherein the RADIUS Server means implements the MILENAGE algorithm.

21. The method of claim 19 or 20 wherein the RADIUS Server means generates, using anti-replay-attack dynamic data, a UMTS Authentication Vector and sends the it to the SGSN means.

22. The method of claim 19 when dependent on claim 18 wherein the RADIUS Server means supports dynamic sequence number (SQN).

23. The method of any one of claims 15-22 wherein the RADIUS Server means generates a UMTS Authentication Vector in a RADIUS attribute within an Access-Accept RADIUS message and sends it to the SGSN means.

24. The method of any one of claims 15-23 wherein the SGSN means receive a UMTS Authentication Vector in a RADIUS Access-Accept message.

25. The method of any one of claims 15-24 wherein the SGSN means sends information to re-synchronise anti-replay-attack information within the USIM with the RADIUS Server means.

26. The method of claim 25 when dependent on claim 18 wherein the SGSN means sends a UMTS-Resynchronisation-Token attribute in the Access-Request RADIUS message.

27. The method of claim 26 wherein the RADIUS Server means resets anti-replay-attack dynamic data in-line with the USIM in response to the data received in the UMTS-Resynchronisation-Token.

28. The method of claim 27 wherein the RADIUS Server means implement the MILENAGE algorithm.

29. A RADIUS Server adapted to perform the method of any one of claims 15-28.

30. A SGSN adapted to perform the method of any one of claims 15-28.

31. A computer program element comprising computer program means for performing the method of any one of claims 15-28.
